(19) United States
(12) Patent Application Publication
(10) Pub. No.: US 2017/0031386 A1
(43) Pub. Date: Feb. 2, 2017

(54) Multi-Screen Display System, Devices and Methods

(71) Applicant: University of Iowa Research Foundation, Iowa City, IA (US)

(72) Inventors: Adam Engel, Williamsburg, IA (US); Kiley Murphy, Davenport, IA (US)

(21) Appl. No.: 15/221,548

(22) Filed: Jul. 27, 2016

Related U.S. Application Data
(60) Provisional application No. 62/197,446, filed on Jul. 27, 2015.

(51) Int. Cl. G06F 1/16; G06F 3/14

(52) U.S. Cl. CPC G06F 1/1641; G06F 3/1446

(57) ABSTRACT

The disclosed apparatus, systems and methods relate to a collapsible, freestanding display unit. The display unit can be a collapsible and transportable stack system, which may include a base unit. The display unit can be erected for temporary use and then easily collapsed and transported to an alternate location.

### CROSS-REFERENCE TO RELATED APPLICATIONS

This application claims priority from U.S. Provisional Application 62/197,446, filed Jul. 27, 2015, and entitled “Multi-Screen Display System, Devices and Methods,” which is hereby incorporated herein by reference in its entirety under 35 U.S.C. §119(e).

### TECHNICAL FIELD

The various embodiments disclosed herein relate to improved methods, systems, and devices for the coordinated display of a plurality of digital screens by way of a collapsible, modular, scalable and freestanding display system.

### BACKGROUND

The disclosure relates to a display system which can be collapsed and expanded, so as to be both capable of being stored in a compact brick and then expanded into a freestanding unified display panel.

There is a need in the art for a modular and scalable digital signage display system that uses digital display devices, such as iPads, tablet computers, video display panels or other video monitors in an eye-catching visual array, which is easily transportable as well as simple to set up.

### BRIEF SUMMARY

Discussed herein are various embodiments of an expandable display system which is modular and scalable, as well as associated systems and methods for its use. For brevity, these embodiments may be described as a “display system”, or in relation to a single modality, though that is not intended to limit the scope of the disclosure in any way.

In Example 1, a display device comprises a plurality of links, further comprising first and second ends; a plurality of connectors, configured such that the display device is collapsible; wherein the plurality of links are configured to provide video display.

In Example 2, the display device of Example 1, wherein the device is configured to be collapsible, so as to be capable of being urged between a collapsed position and an upright position.

In Example 3, The display device of Example 2, further comprising a plurality of housings further comprising at least one display opening per housing disposed on the links.

In Example 4, The display device of Example 3, wherein two housings are disposed per link.

In Example 5, The display device of Example 3, wherein each link has a first and second side, and the housings are disposed on either side such that the display openings are oriented on opposite sides.

In Example 6, the display device of Example 5, further comprising a plurality of spacers.

In Example 7, the display device of Example 5, wherein the display device is configured to be collapsed into a transportable collapsed position.

In Example 8, the display device of Example 7, further comprising at least one wheel and a handle.

In Example 9, the display device of Example 7, further comprising at locking mechanism disposed about the hinges and adapted to hold the device in the upright position.

In Example 10, a collapsible display system comprising a collapsible display unit, further comprising a plurality of links comprising first and second ends and disposed end-to-end in a generally stacked arrangement having a top and bottom; a plurality of hinges; at least one video display; and a base unit; and an operations interface; wherein the hinges are disposed between the first and second ends of the links in the stacked arrangement and between the second end of the bottom link and the base unit; and further wherein the operations interface is in operational communication with the at least one video display.

In Example 11, the display system of Example 10, further comprising a plurality of housings further comprising at least one display opening per housing disposed on the links.

In Example 12, the display system of Example 11, wherein two housings are disposed per link.

In Example 13, the display system of Example 11, wherein each link has a first and second side, and the housings are disposed on either side such that the display openings are oriented on opposite sides.

In Example 14, the display system of Example 11, further comprising an external communications unit in electronic communication with the operations interface.

In Example 15, the display system of Example 14, wherein the operations interface is disposed within the links to perform a support for the video display selected from the group consisting of: providing power, providing a communications signal, providing digital input, receiving digital output, and receiving audio output.

In Example 16, the display system of Example 11, further comprising at least one additional opening disposed within the system.

In Example 17, the display system of Example 16, wherein the additional opening is selected from the group consisting of power cord openings, speaker openings, wire openings, and button openings.

In Example 18, the display system of Example 10, wherein the system is configured to house at least one commercially-available video display.

In Example 19, the display system of Example 18, wherein the display system is configured to house at least one iPad.

In Example 20, the display system of Example 10, wherein the system further comprises at least one video monitor and at least one processing unit.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a front view of an exemplary embodiment of the display system in the display position.

FIG. 1B is a back view of an exemplary embodiment of the display system in the display position.

FIG. 1C depicts a perspective view of a further embodiment of the display system.

FIG. 2A is a side view of two links joined by a hinge, according to an exemplary embodiment.

FIG. 2B is a side view of one embodiment of the display system in the collapsed position.

FIG. 2C is a side view of the embodiment of FIG. 2B in an expanding position.

FIG. 2D is a side view of the embodiment of FIG. 2B in the fully erected display position.

FIG. 3A is a side view of an exemplary embodiment comprising multiple display housings per link in an expanding position.

FIG. 3B is a close-up side view of the embodiment of FIG. 3A.

FIG. 3C is a side view of the embodiment of FIG. 3A in the fully erected display position.

FIG. 4A is a side view of an exemplary embodiment comprising multiple display housings per link in an expanding position, and further comprising a locking system.

FIG. 4B is a close-up side view of the embodiment of FIG. 4A.

FIG. 5A is a front view of an exemplary embodiment comprising a locking system.

FIG. 5B is a close-up cutaway view of the embodiment of FIG. 5A.

FIG. 6A is a front and back view the display system comprising display housings on the front and back, according to an exemplary embodiment.

FIG. 6B is a front and back view the display system comprising display housings on the front only, according to an exemplary embodiment.

FIG. 7 is a close-up perspective view of the housings, links and hinges, according to an exemplary embodiment.

FIG. 8A depicts an exemplary embodiment of the display system in the compact position.

FIG. 8B depicts an exemplary embodiment of the display system being transitioned from the compact position to the display position.

FIG. 8C further depicts an exemplary embodiment of the display system being transitioned from the compact position to the display position.

FIG. 9A depicts an exemplary embodiment of the mast of the display system being assembled into the display position.

FIG. 9B further depicts an exemplary embodiment of the mast of the display system being assembled into the display position.

FIG. 9C depicts an exemplary embodiment of an additional step in transitioning the display system into the display position.

FIG. 9D depicts an exemplary embodiment of the mast fully extended into the display position.

FIG. 10A depicts a top view of an exemplary embodiment of the display system in the compact position and with the base units expanded.

FIG. 10B depicts an additional view of an exemplary embodiment of the display system in the compact position and with the base units expanded

FIG. 10C depicts a side view of an exemplary embodiment of the display system in the compact position and with the base units expanded

FIG. 10D depicts another view of an exemplary embodiment of the display system in the compact position and with the base units expanded

FIG. 10E depicts a flat view of the base units expanded.

FIG. 10F depicts an additional flat view of the base units expanded

FIG. 10G depicts an in-use drawing of an embodiment of the display system in the collapsed position and being wheeled by a user.

FIG. 11A depicts an exemplary embodiment of the display system being transitioned from the display position to a more compact position.

FIG. 11B depicts an exemplary embodiment of the first stage of the display system being transitioned from the display position to a more compact position.

FIG. 11C depicts an exemplary embodiment of the second stage of the display system being transitioned from the display position to a more compact position.

FIG. 11D depicts an exemplary embodiment of the third stage of the display system being transitioned from the display position to a more compact position.

FIG. 11E depicts an exemplary embodiment of the fourth stage of the display system being transitioned from the display position to a more compact position.

FIG. 11F depicts an exemplary embodiment of the connector used to adjust the display system.

FIG. 12A depicts an exemplary embodiment of display system partially moved into the compact position with respect to the base unit.

FIG. 12B depicts an exemplary embodiment of display system prepared to be moved into the compact position with respect to the base unit.

FIG. 12C depicts an exemplary embodiment of the base unit.

FIG. 13 depicts a schematic overview of network and software architecture used in certain implementations of the system.

FIG. 14 depicts a schematic overview of an alternative embodiment of the system wherein the display screens are pre-installed and internally operated.

### DETAILED DESCRIPTION

The various embodiments disclosed and contemplated herein relate to a collapsible display, including, in various implementations, a collapsible display that can be used in conjunction with a plurality of display screens. In exemplary embodiments, the disclosed display system comprises a collapsible frame which is capable of folding into a transportable unit and housing at least one display screen.

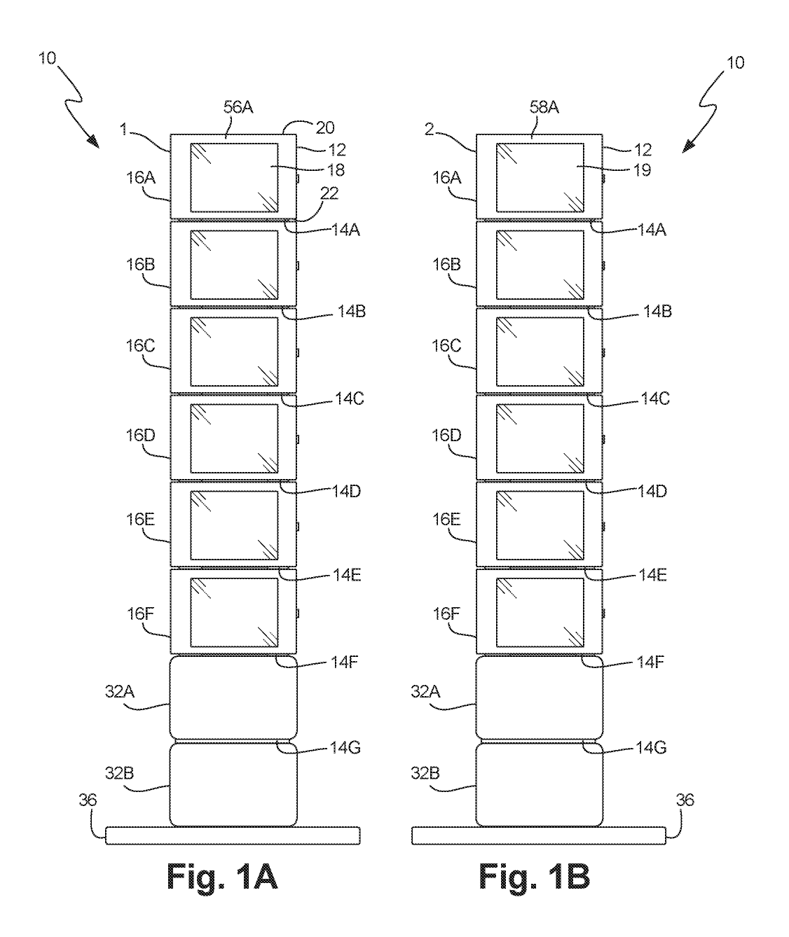

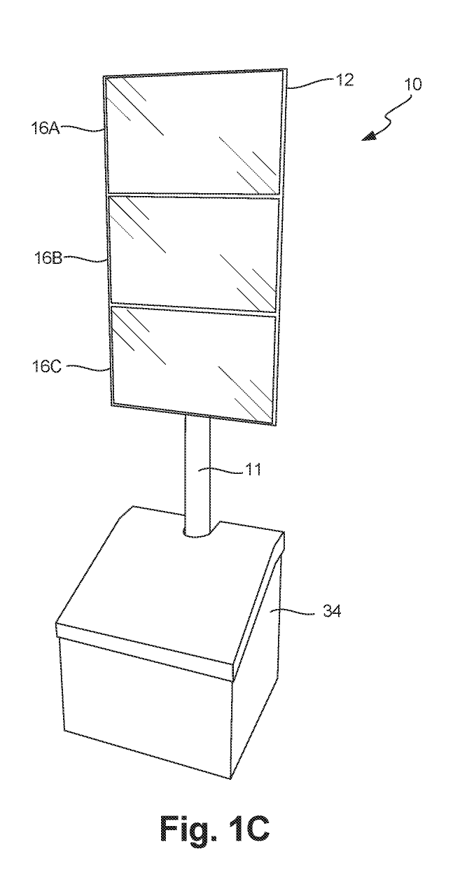

As is depicted in FIGS. 1A-1B, exemplary embodiments of the display system 10 comprise a frame 12 having a plurality of hinges 14A, 14B, 14C, 14D, 14E, 14F, 14G. In various implementations, the frame further comprises a plurality of links 16A, 16B, 16C, 16D, 16E, 16F. The links further comprise a first side 1 and a second side 2. In exemplary embodiments, at least one side has at least one display opening 18.

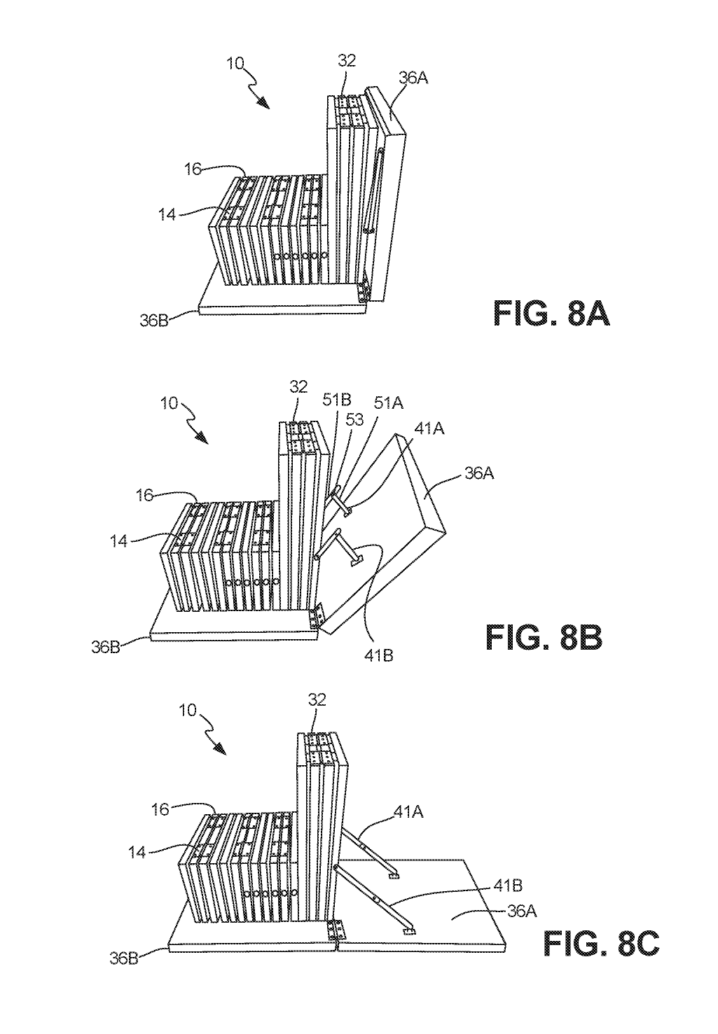

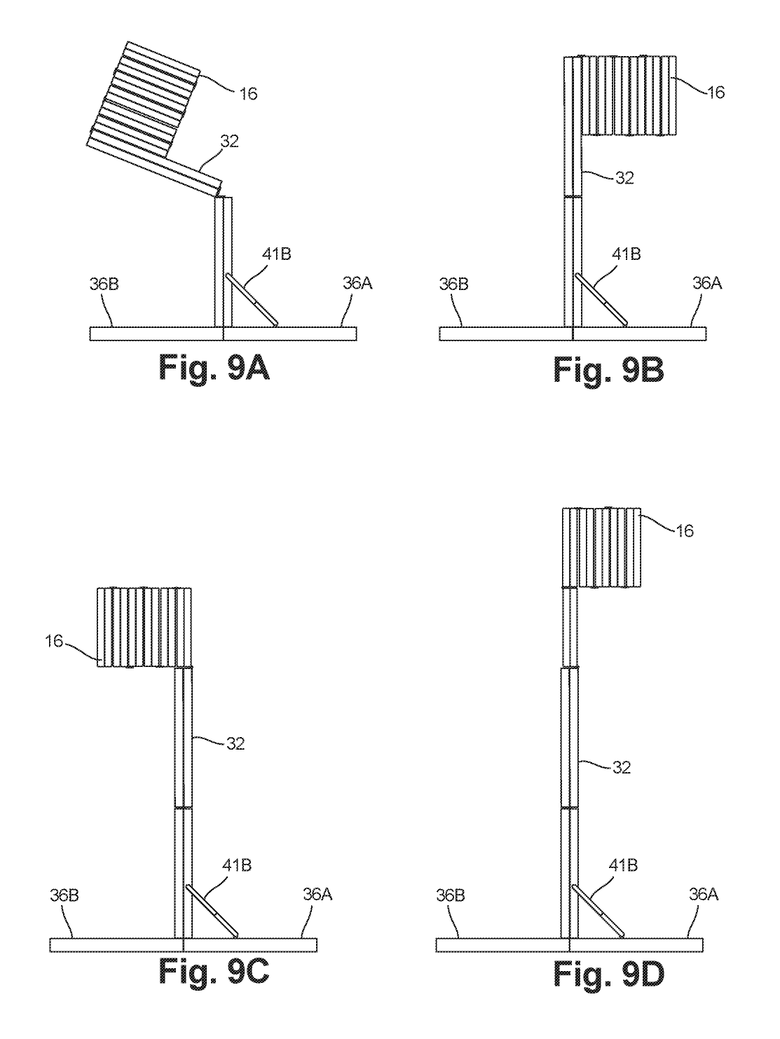

As is shown in FIG. 1B, in certain embodiments a second display opening 19 can be provided on the side 2 opposite the first 18. In exemplary embodiments, each link further comprises a first 20 and second 22 end, and the links are “stacked” atop one another. Owing to the presence of the hinges (generally 14), the display system 10 is configured so as to be capable of being variously positioned between an upright, or display position, and a collapsed, storage or portable position, as is described herein in relation to FIGS. 8-9.

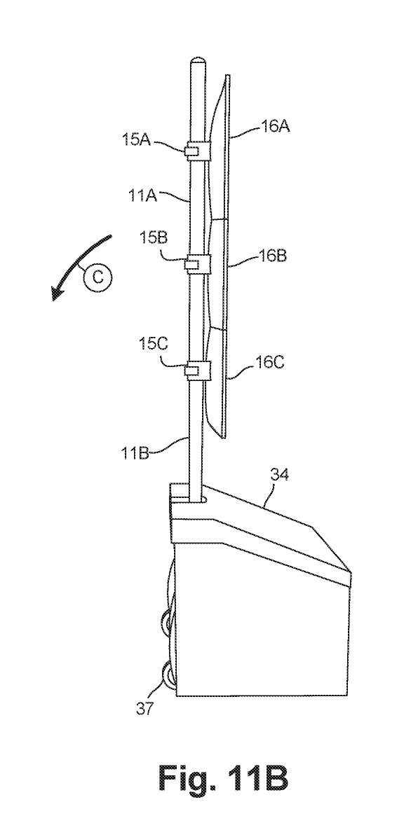

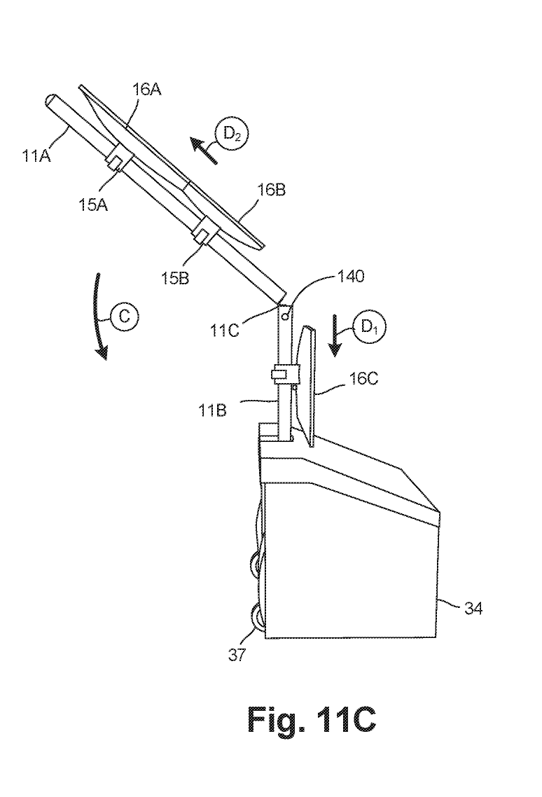

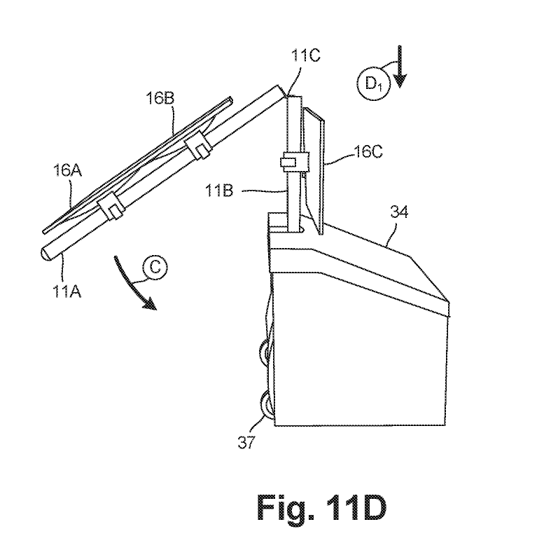

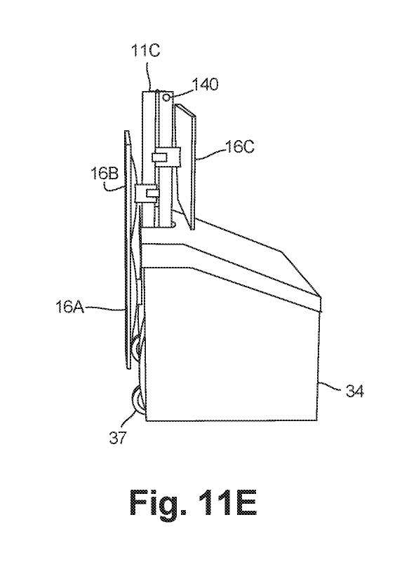

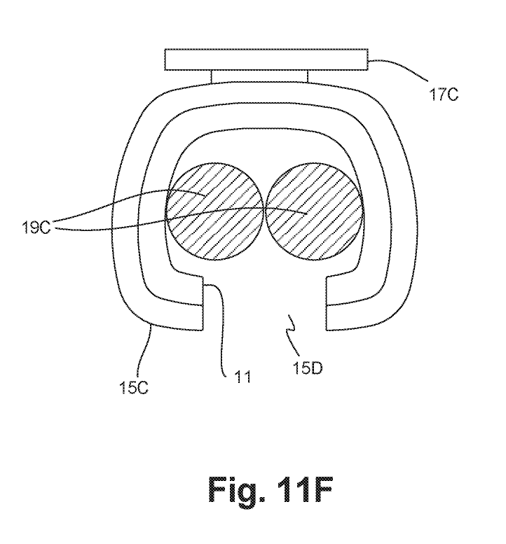

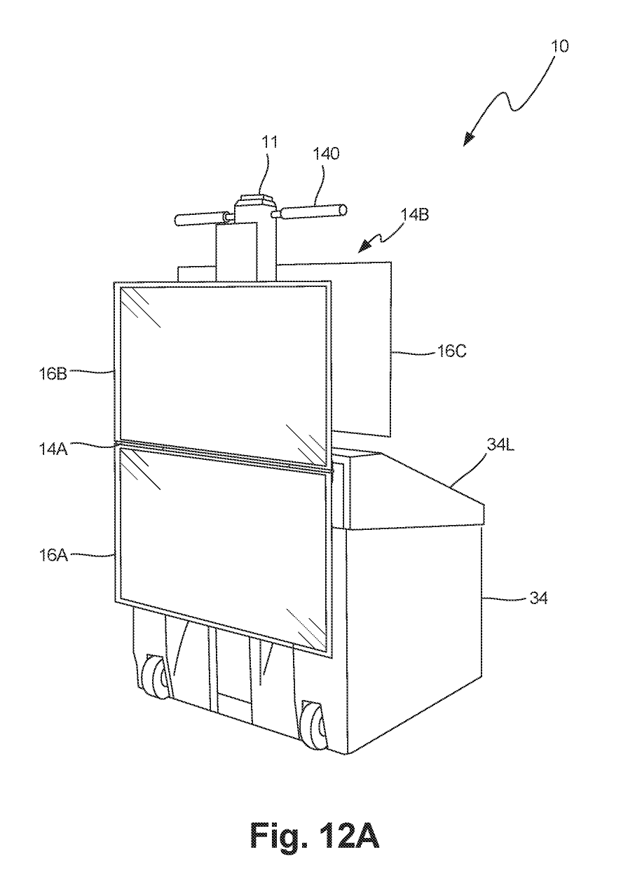

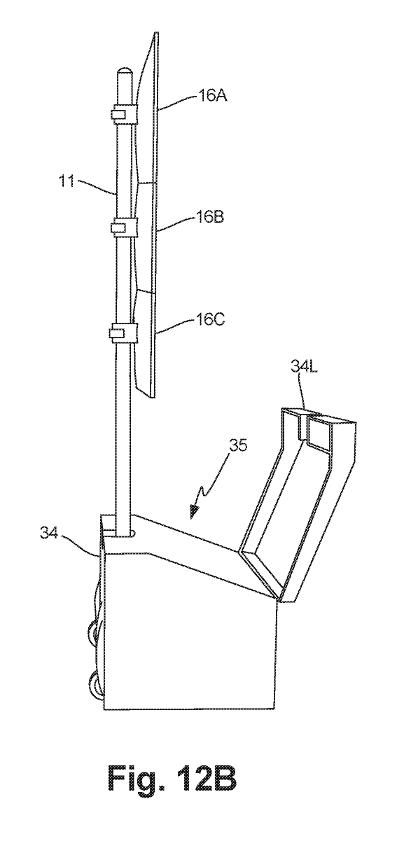

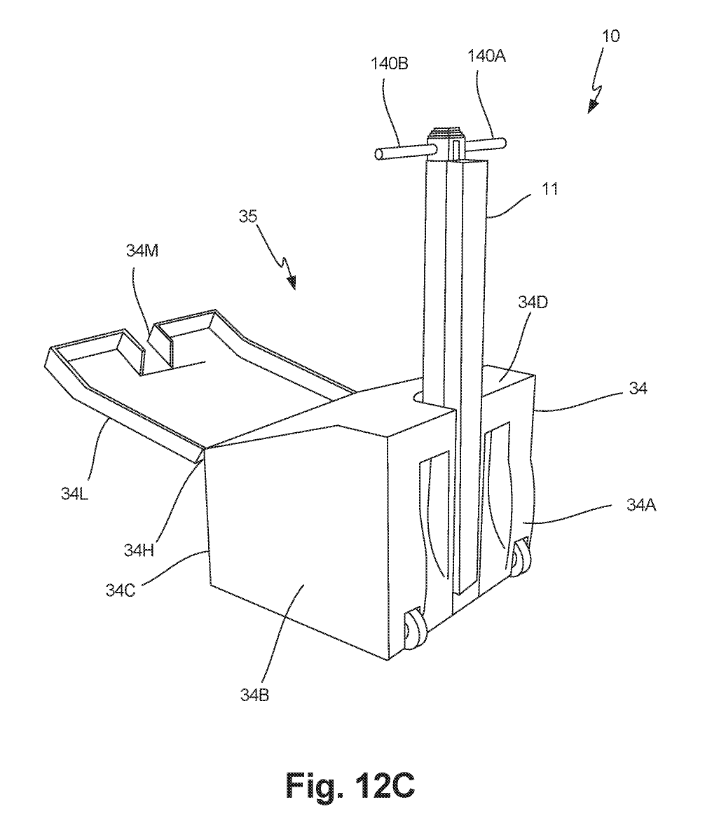

FIG. 1C depicts a further implementation of the display system 10. In this implementation, the display system 10 has a frame 12 supported on a mast 11. The frame 12 has a plurality links 16A, 16B, 16C, but in this implementation, the mast 11 extends between the base unit 34 and the lowermost end of the links 16C. The operation and movement between the erect and collapsed positions is described herein in relation to FIGS. 11A-D. It is understood that in this implementation, the base unit 34 can also comprise the carrying case, as is discussed below in relation to FIGS. 12A-D.

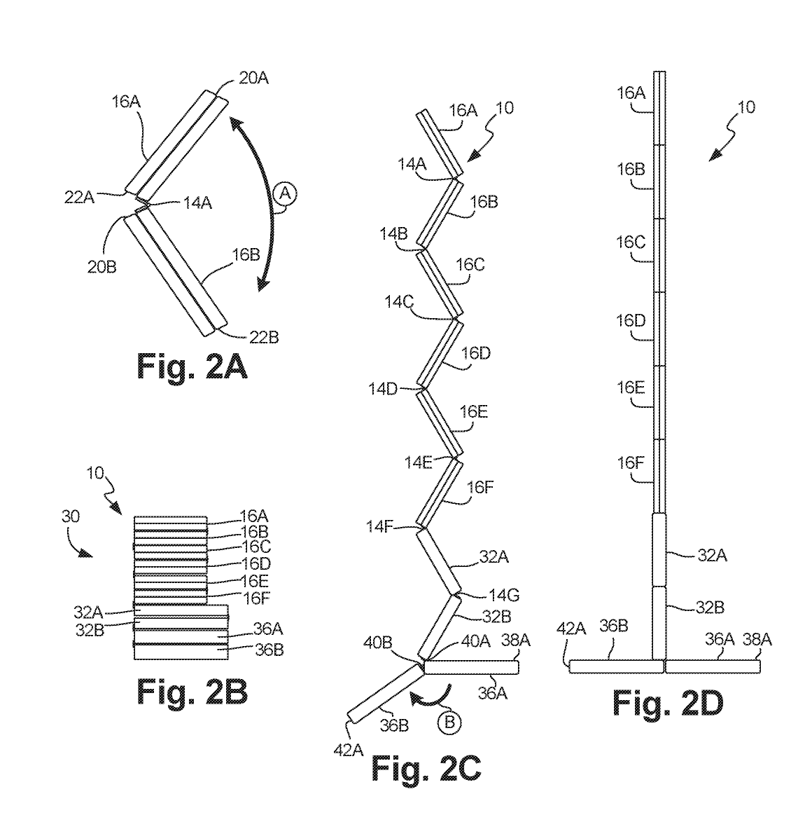

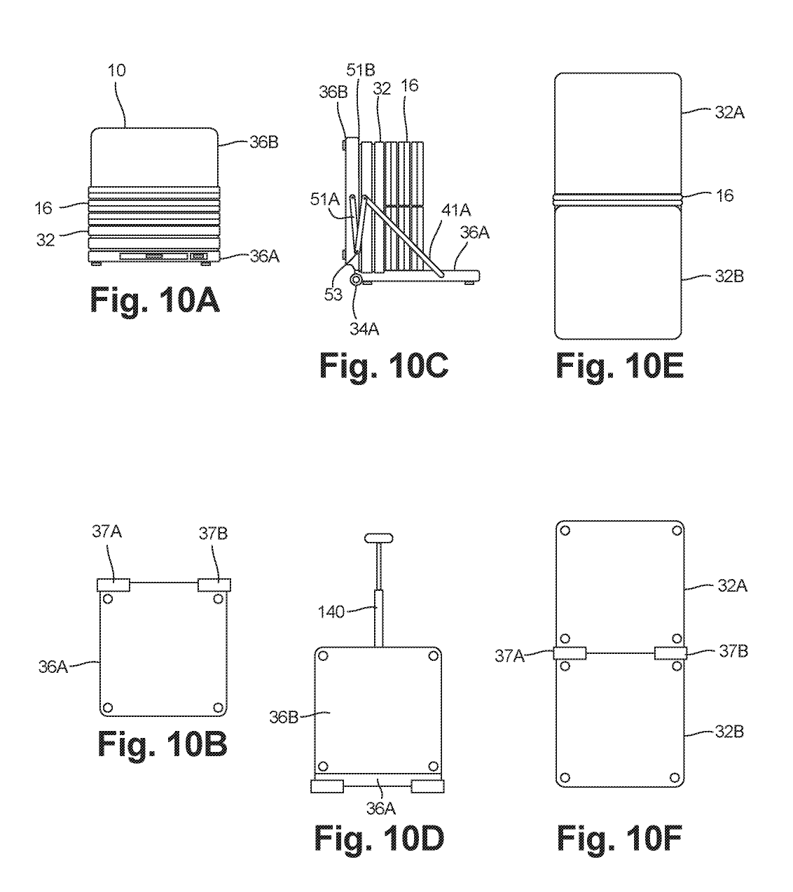

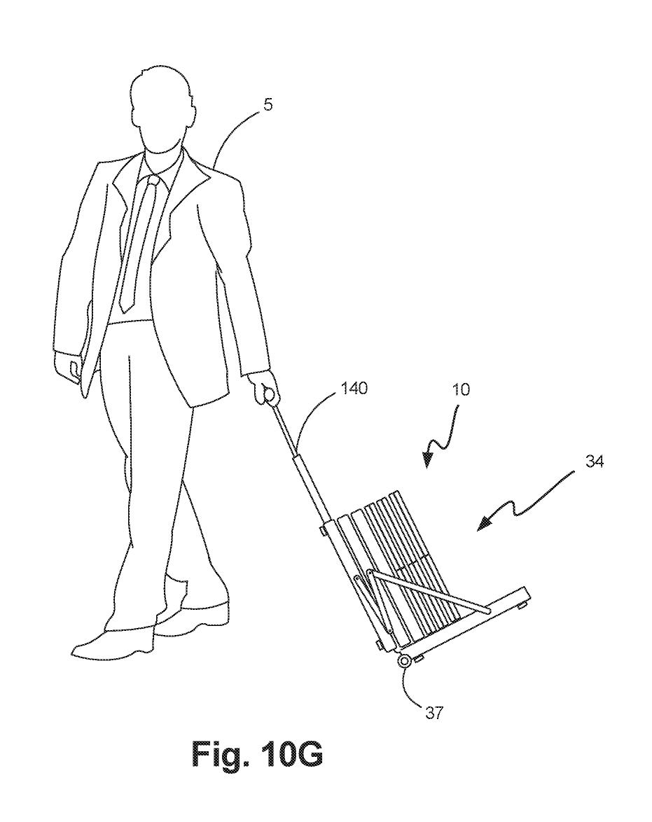

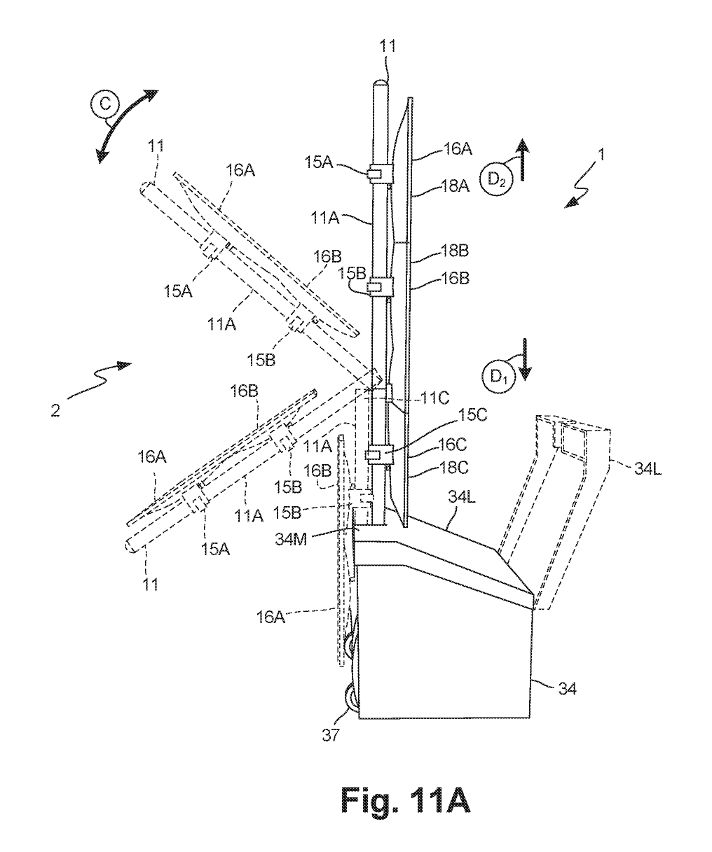

FIGS. 2A-2D depict an exemplary embodiment of the display system 10, showing the ability of the display system 10 to be collapsed into the storage configuration (as best shown in FIG. 2B). As is depicted in FIG. 2A, in exemplary embodiments, the collapsible display system 10 comprises a plurality of links 16A, 16B which are disposed on either side of a hinge 14A. The hinge 14A and links 16A, 16B are oriented in a “stack,” such that the hinge is disposed in a generally horizontal plane such that the links 16A, 16B can be freely rotated about the hinge 14A so as to bring them from the end-to-end configuration in the display position, wherein the first end 20A of the top link 16A is opposite the second end 22B of the bottom link, into the collapsed position, wherein the links 16A, 16B are moved into an aligned orientation such that the first end 20A of the top link is brought adjacent to the second end 22B of the bottom link 16B, as is shown by reference arrow A. In so doing, the plurality of links 16A, 16B, 16C, 16D, 16E, 16F can be collapsed into a condensed shape 30, so as to be capable of being stored and or transported by way of a compact carrying case (shown in FIGS. 10A-11).

As is also shown in FIG. 2B, in certain embodiments, the display system 10 further comprises at least one spacer section 32A, 32B and a base unit 34 comprising at least one base support 36A, 36B. While the embodiment shown in FIGS. 2A-D has links of a first length and spacers and base units of a second length, in alternative embodiments the lengths of each of these components can vary as needed.

FIG. 2C-D depict the corresponding movement from the collapsed position into the display position (FIG. 2D), wherein the plurality of links 16A, 16B, 16C, 16D, 16E, 16F and spacer sections 32A, 32B are brought into a generally linear alignment by way of the hinges 14A, 14B, 14C, 14D, 14E, 14F, 14G, (one of which 14G is disposed between the spacer sections 32A, 32B). As is also shown in FIG. 2C, a plurality of base hinges 40A, 40B are disposed between the base supports 36A, 36B so as to foldably attach to the lowest spacer 32B or link, and further allow the first base support 36A to be oriented such that the first end 38A can be extended in a substantially perpendicular direction from the display portion when erect 50, such that it lays flush against the floor or other support (not shown). The second base support 36B is correspondingly aligned in the opposite direction such that the first end 42A can be oriented substantially 180 degrees from the first end 38A of the first base support 36A, as is shown by reference arrow B, and is shown in FIG. 2D, wherein the display system is in the fully upright position.

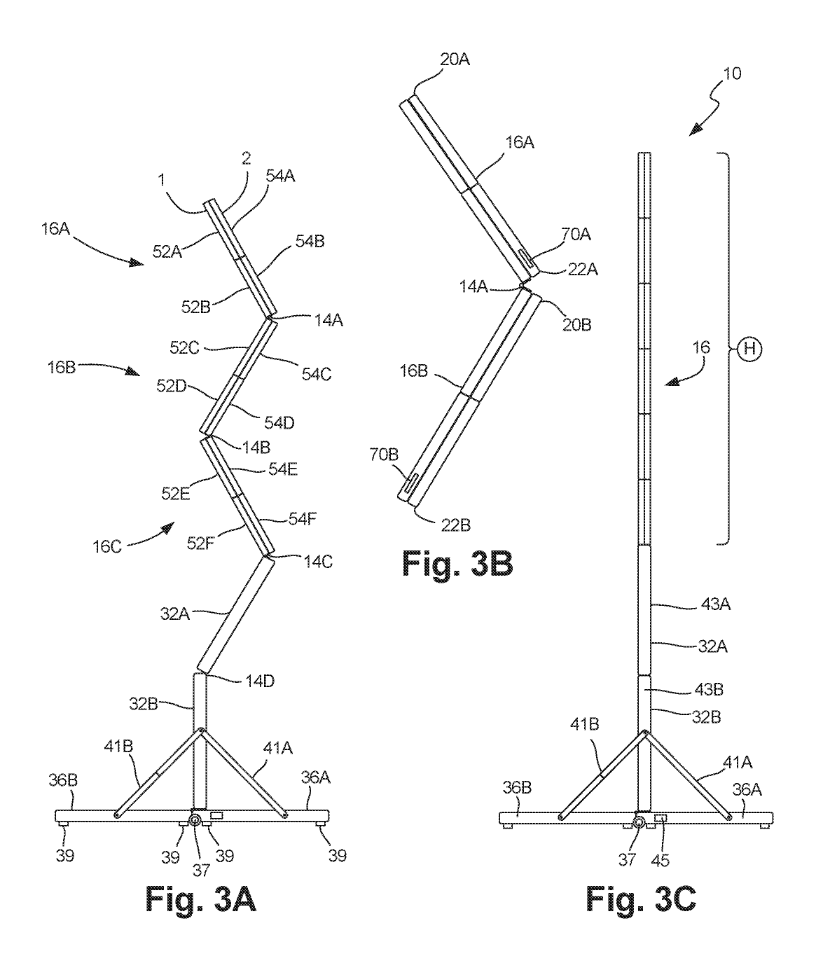

FIGS. 3A-3C depict an alternative embodiment of the display system 10, wherein each link 16A can further comprise two or more housings 52A, 52B, 54A, 54B vertically, as well as on either side 1, 2. In these configurations, the housings are disposed 52A, 54A, 52B, 54B, 52C, 54C, 52D, 54D, 52E, 54E, 52F, 54F such that each housing is configured to encase one digital display such that the digital displays are visible through the openings on either side of the display system (by way of example, FIG. 1A-B depicts displays 56A, 58A on either side 1, 2).

In these embodiments, the display system further comprises at least one support bar 41A, 41B disposed between the base unit 36A, 36B and spacer 32B, so as to provide rigid positioning support to the portion comprising spacers 32 and links 16 (this is depicted further in relation to FIGS. 8A-9D). FIGS. 3A-3C also depict that in certain implementations, the base unit 36 further features at least one wheel 37 (as is discussed in relation to FIGS. 10A-11), and can also feature a plurality of feet 39 disposed on the underside of the base unit 36.

As is shown in FIG. 3B, again, the plurality of links 16A, 16B are brought into a generally linear alignment by way of the hinges 14A, such that the second 22A and first 20B ends of successive links 16A, 16B are urged flush. Further, these embodiments may feature at least one locking pin 70A, 70B, which may be disposed between individual links 16A, 16B so as to selectively secure the links in the upright orientation for display. As is depicted in FIG. 3B, the locking pins 70A are shown disposed in the second ends 22A, 22B of the links, though they could likewise be disposed in the first ends or as part of a mechanism housed in both ends around a hinge 14A, as would be apparent to one of skill in the art. In various alternative embodiments, a variety of similar locking or stabilizing components may be used, such as locking hinges, magnets, and the like.

Further, as is shown in FIG. 3C, in certain exemplary embodiments, the spacer units 32A, 32B may further comprise speakers 43A, 43B set inside the spacers, so as to enable the broadcasting of sound to accompany the images which are depicted by the links 16. Further, the base unit may comprise an internal power cord unit 45, such that the displays may be powered by the system by way of a master power cord (not shown). In certain embodiments, the system further comprises an internal power cord reel (not shown), such that the system power cord may be stored within the base unit 36 when not in use but extended from the reel when needed. Other embodiments are possible. As is depicted by the reference bracket H, in certain embodiments, the height of the display portion of the device is contemplated to be around 7 feet off the ground, with the spacers 32A, 32B making the bottom 22B of the display portion H approximately 3 feet off the ground, so as to maximize ability to be viewed by a standing person. As would be apparent to one of skill in the art, other configurations are of course possible.

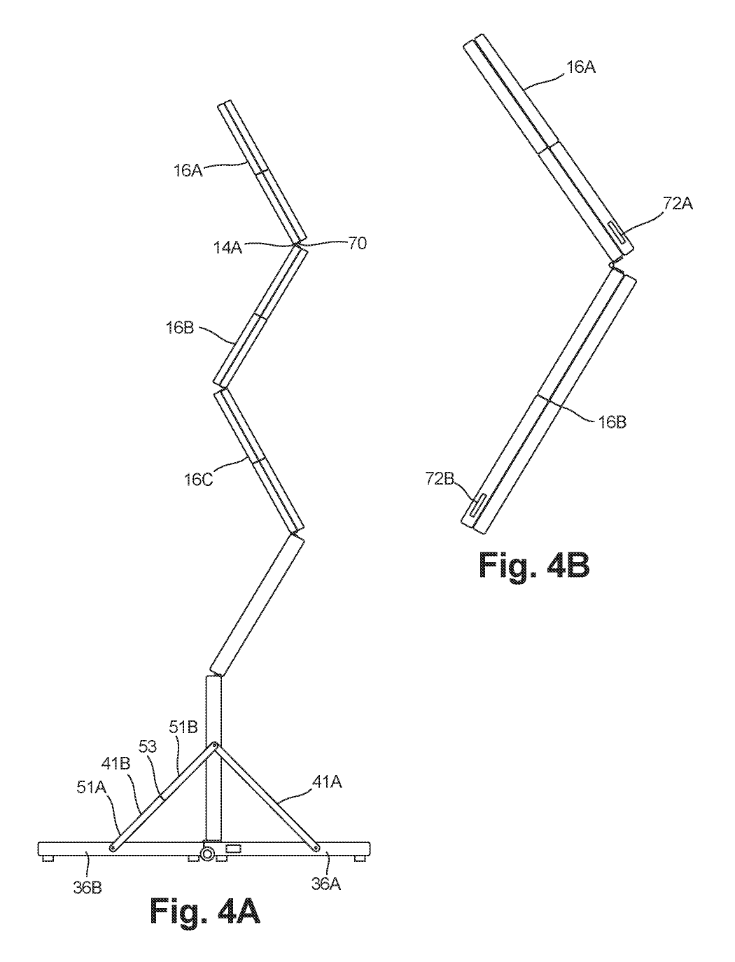

As is shown in FIGS. 4A-4B, in exemplary embodiments, the system may further comprise an automatic locking pin system 70 which comprises locking pin releases 72A, 72B, such that the links 16A, 16B automatically lock into the upright position, and are accordingly releasable by pressing a button 72A, 72B or otherwise activating the releases when collapsing the system 10, as would be apparent to one of skill in the art. Further, in exemplary embodiments, certain of the support bars 41 may be single piece, while others may comprise a plurality of articulating portions 51A, 51B around a hinge 53, so as to accommodate the folding into the collapsed position, as is shown in FIGS. 8A-8C.

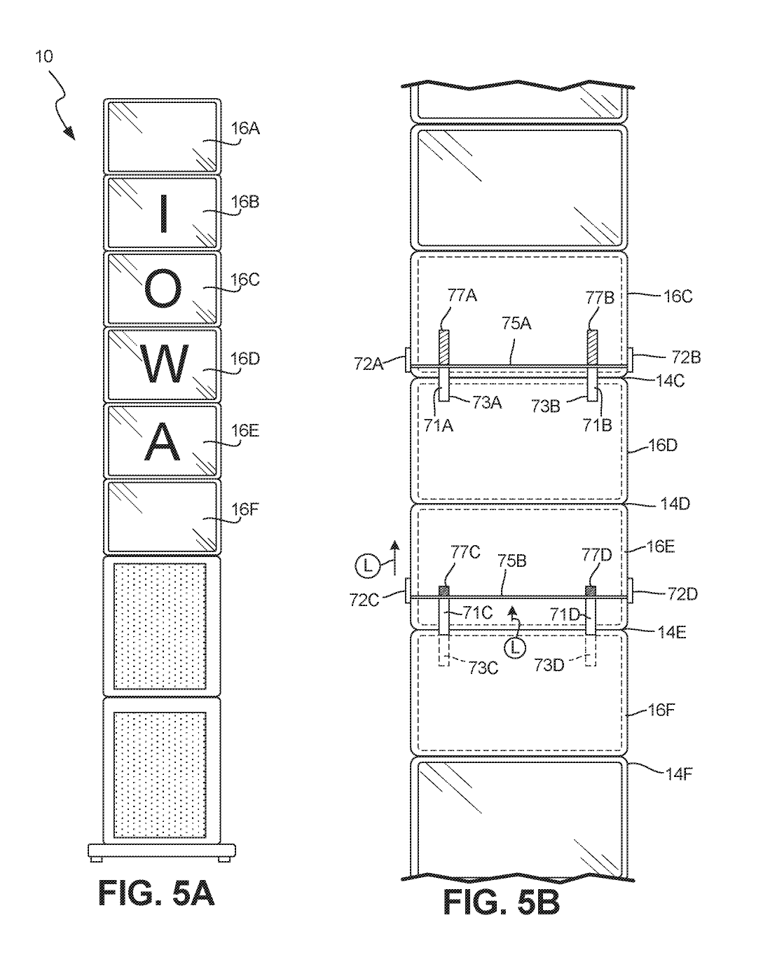

As is further shown in the embodiments of FIGS. 5A-5B, in exemplary embodiments, the locking pin system 70 can further comprise a plurality of release buttons 72A, 72B, 72C, 72D, which are in corresponding mechanical communication with the locking pins 70A, 70B, 70C, 70D, so as to actuate their unlocking, as is shown in FIG. 5B at hinge 14E. In these embodiments, the buttons 72A, 72B, 72C, 72D are slidably coupled to the links and a bar 75A, 75B so as to urge the bar and pins 71A, 71B, 71C, 71D away from the female regions 73A, 73B, 73C, 73D, so as to release the links 16C, 16D, 16E, 16F to freely rotate relative to one another, as is shown at reference arrow L. In certain embodiments, a plurality of springs 77A, 77B, 77C, 77D are also provided, so as to urge the pins into place. Other configurations are possible.

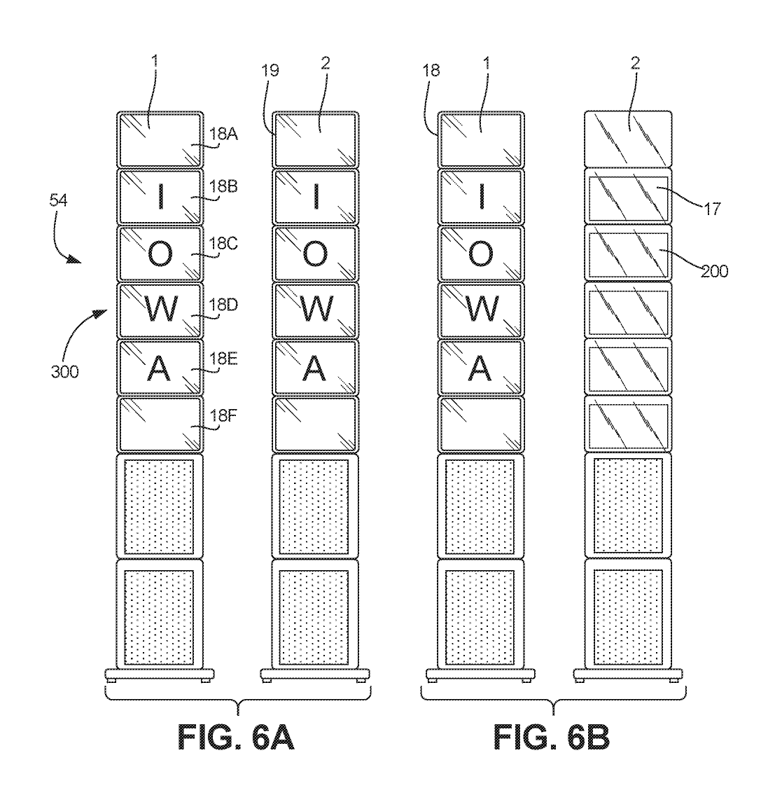

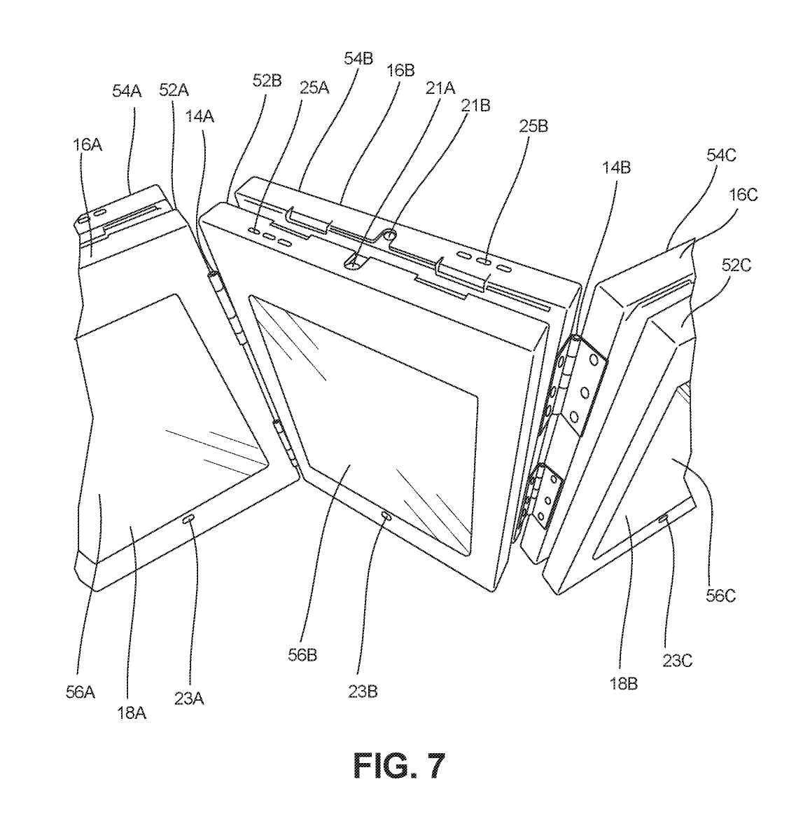

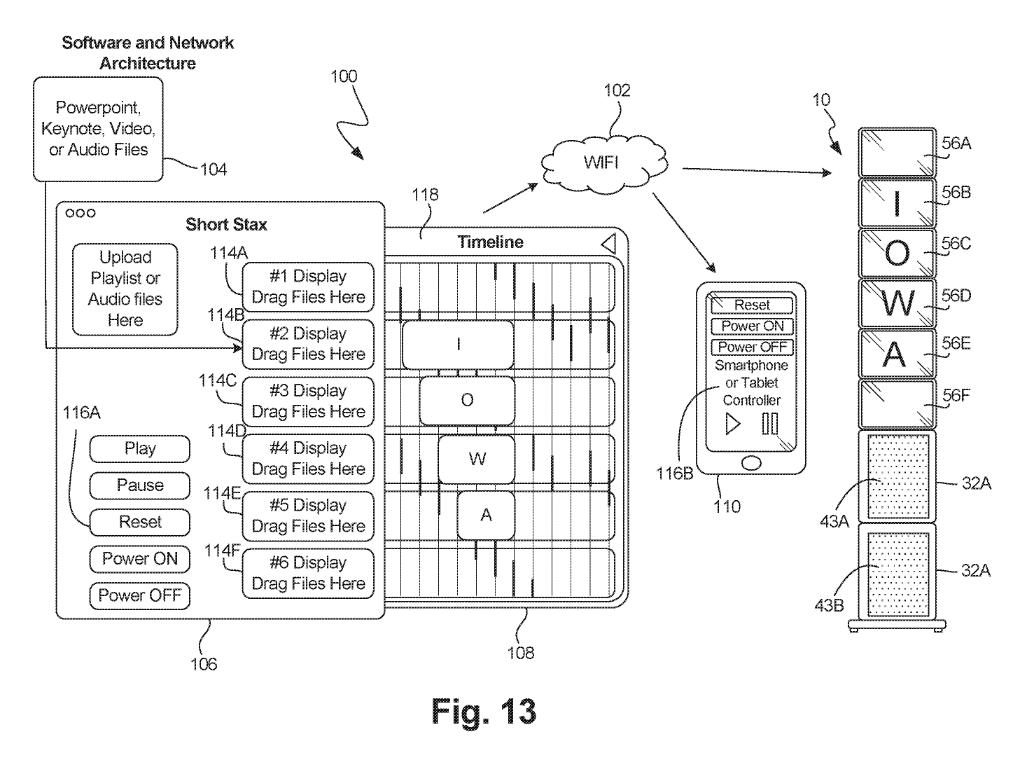

As is shown in FIG. 6A, in certain embodiments, both the first side 1 and second side 2 comprise display openings 18, 19, while in alternative arrangements (FIG. 6B), the second side may feature a plurality of alternative housings, such as those configured for holding brochures 200. In FIG. 6, in exemplary embodiments, the display system's 10 display housings 54 are oriented in the landscape orientation, so as to accommodate and display the electronic devices in the same orientation. In these embodiments, the links can further comprise mounting jacks, which are in electronic communication with a power unit (not shown) so as to allow the individual displays 18A, 18B, 18C, 18D, 18E, 18F to receive a continuous power source and/or electronic communication from a centralized control system (as described in relation to FIGS. 12-13) so as to display a coordinated image 300.

FIG. 7 depicts a detailed view of a plurality of links 16A, 16B, 16C and hinges 14A, 14B according to an exemplary embodiment. In certain embodiments each link can further comprise two or more housings 52A, 54A, 52B, 54B, 52C, 54C, such that each housing is configured to encase one digital display 56A, 56B, 56C, 58A such that the digital displays are visible through the openings on either side of the display system (FIG. 1A-B depicts displays 56A, 58A on either side 1, 2). As is shown, these housings have display openings 18A, 18B, 18C. FIG. 7 also depicts a variety of additional openings 21A, 21B, 23A, 23B, 23C, 25A, 25B, which can be used to provide power to the displays 21A, 21B, interact with the digital display buttons 23A, 23B, 23C, provide speaker openings 25A, 25B and the like. In exemplary embodiments, the housings comprise internal docking ports (not shown), which may be wired together to provide all the displays with power. For example, iPad docking USB cables may be provided.

FIGS. 8A-9D depict the unpacking of the display system 10 can certain embodiments, wherein the base supports 36A, 36B are positioned against the floor, and the spacers 32 and links 16 are extended out about the hinges 14. As is shown at FIG. 8B-8C, in these embodiments a plurality of jointed support bars 41A, 41B are disposed between the base unit 36A and spacer, the support bar 41A further comprising a plurality of articulating portions 51A, 51B around a hinge 53. As is apparent from FIGS. 8A-9D, the spacer(s) 32, link(s) 16 and other portions can be sequentially positioned into the upright position, by way of, for example, the locking pins (described herein in relation to FIGS. 3A-5B), for example. Other methods are of course possible.

FIGS. 10A-10F depict a variety of alternative views of the system 10, comprising links 16, spacers 32, wheels 37A, 37B and support bars 41A, 41B, 51A, 51B and support bar hinges 53. As is shown in FIGS. 10D and 10F, in certain embodiments the base unit 34 may further comprise a handle 140, which may be expandable, so as to allow the user 5 to wheel the system 10, for example in an airport or at a conference center.

FIG. 11A-E depict various views of the implementation of FIG. 1C. As is shown in FIG. 11A, in these implementations, the display system 10 has a plurality of links 16A, 16B, 16C disposed on the mast 11, which in turn is capable of being folded into a collapsed position such that links 16A, 16B, 16C are disposed on either side 1, 2 of the mast 11 for transport, as is shown by reference arrow C. Further, in certain implementations, some or all of the links 16A, 16B, 16C can be in slidable communication with the mast 11, as is shown generally by reference arrows D₁ and D₂. Further, in various implementations, the links 16A, 16B, 16C can be removed and stored, such as in the base unit 34 in implementations where the base unit comprises a cargo opening, which is discussed further in relation to FIGS. 12A-D.

As best shown in FIGS. 11A-E, in these implementations, the mast 11 comprises upper 11A and lower 11B portions, and a central pivot 11C. In various implementations, each of the links 16A, 16B, 16C is coupled to the mast 11 with a connection point 15A, 15B, 15C, such that the links 16A has a display opening 18A, 18B, 18C which is oriented toward the same side 1 when in the erect position. It is understood that in alternate embodiments, links or display openings can also be disposed on the second side 2 when in the erect position.

In the implementation of FIGS. 11A-E, the lowermost link 16C is slidably connected to the mast 11 through the connection point 15C, so as to be capable of being urged into proximity to the base unit 34, as is shown by reference arrow D₁ and discussed further in relation to FIG. 12A. Further, the uppermost links 16A, 16B are also slidably connected to the mast 11 so as to be capable of being urged away from the base unit 34 when in the erect position, or away from the central pivot 11 (as is shown by reference arrow D₂). It would be understood by one of skill in the art that various connection apparatus, such as clamps, tightening screws, or other well-known attachments can be used as selectively slidable connection points 15A, 15B, 15C.

The connection apparatus of the links 16A, 16B, 16C is a clip 15A, 15B, 15C. An exemplary implementation of a clip 15C is shown in FIG. 11F. In this implementation of the clip 15C, it is slidable along the mast 11 to allow for variable placement along the mast 11. The opening 15D will allow for easy cable management to facilitate the ease of set up and tear down for power, video, and audio input cords. The link 16C is attached to the clip 15C by a mount 17C. In the implementation of FIGS. 11A-E, the uppermost links 16A and 16B are slidably coupled to the upper mast portion 11A, such that when the mast is rotated about the central pivot 11C into the collapsed position, these links 16A, 16B are disposed on the opposite side of the mast 11 and the lowermost link 16C, below the handle 140. It is understood that in these implementations, the lower hinge 14B is the central pivot 11C, rather than being disposed directly between the links 16B, 16C, as was discussed above in relation to the implementations of FIGS. 1A-B and 2A-D.

Continuing with FIGS. 12A-C, in these implementations, the handle 140 can comprise a plurality of handle portions 140A, 140B disposed from the mast 11. It is understood that in the collapsed position, as shown in FIG. 11D, the links 16A, 16B, 16C in these implementations are disposed sufficiently distally on the mast 11 such that the user has sufficient space to access the handle portions 140A, 140B from various angles so as to facilitate transport—such as rolling transport—of the system 10.

As is best shown in FIG. 12A-C, in various implementations the base unit 34 can have a cargo opening 35 disposed within the base sides 34A, 34B 34C, 34D and cover or “lid” 34L. Continuing with the implementation of FIGS. 12A-C, in certain implementations the lid 34L can further have a mast opening 37M, such that when the lid 34L is placed over the cargo opening 35, the mast 11 is disposed within the mast opening 34M. Further, in certain implementations, the lid 34L can pivot around a cover hinge 34H. It is understood that in various applications, the cargo opening 35 can be used to store the links 16A, 16B, 16C, electrical equipment, or other material related to the use of the system 10, such as pamphlets and/or literature, business cards and the like.

FIG. 13 depicts a model overview of exemplary embodiments of the system 10 that further comprise software and network architecture 100 configured to coordinate the display of images and or sound between the individual displays 56A, 56B, 56C, 56D, 56E, 56F and spacer 32A, 32B speakers 43A, 43B. In these embodiments, a WiFi connection 102 may be utilized to coordinate the activity of the various screens by way of an application 106, 110 running on a desktop computer or mobile device. In certain embodiments, a slideshow or other presentation file 104 can be created which is routed by the application 106, 110 so as to coordinate the display and transition of images 102 and sounds between the individual displays 56A, 56B, 56C, 56D, 56E, 56F.

In exemplary embodiments, this can be accomplished by dropping individual files into a plurality of segregated modules 114A, 114B, 114C, 114D, 114E, 114F such that each presentation file is coordinated with a specific display 56A, 56B, 56C, 56D, 56E, 56F, and can be controlled by a plurality of action interfaces 116A, 116B so as to appear together on a coordinated timeline 118.

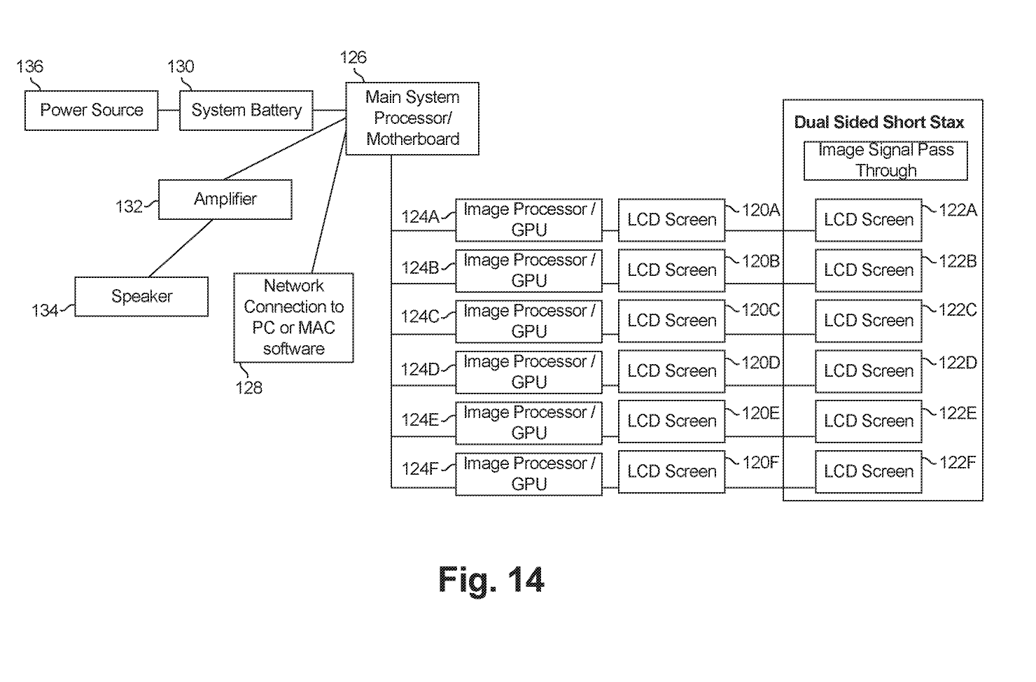

As shown in FIG. 14, alternative embodiments of the system 10 may comprise installed displays, rather than housings, in each of the links. Accordingly, in various embodiments, the end user is able to either install their own devices, such as iPads or other tablets, or the system can come pre-installed with a plurality of displays 120A, 120B, 120C, 120D, 120E, 120F, which may appear on one or both sides 122A, 122B, 122C, 122D, 122E, 122F of the system 10. Importantly, in certain implementations, both sets of paired displays 120A, 122A may be run by way of a single image processing unit or graphics processing unit 124A, which can serve to save weight and cost in these implementations. Further, in various implementations, a main system processor 126, network connection 128, battery 130, amplifier 132, speaker 134 and power source 136 may also be provided, so as to enable the creation of a stand-alone computing device within the system 10, such that it may be manufactured specifically for this purpose, save weight and overall cost by not relying on the purchase of third-party tablet devices.

Although the disclosure has been described with reference to preferred embodiments, persons skilled in the art will recognize that changes may be made in form and detail without departing from the spirit and scope of the disclosed apparatus, systems and methods.

What is claimed is:

1. A display device comprising:
a. a plurality of links, further comprising first and second ends;
b. a plurality of connectors, configured such that the display device is collapsible, disposed between the first and second ends of the links; and
c. a base unit;
wherein the plurality of links are configured to provide video display.

2. The display device of claim 1, wherein the device is configured to be collapsible, so as to be capable of being urged between a collapsed position and an upright position.

3. The display device of claim 2, further comprising a plurality of housings further comprising at least one display opening per housing disposed on the links.

4. The display device of claim 3, wherein two housings are disposed per link.

5. The display device of claim 3, wherein each link has a first and second side, and the housings are disposed on either side such that the display openings are oriented on opposite sides.

6. The display device of claim 5, further comprising a plurality of spacers.

7. The display device of claim 5, wherein the display device is configured to be collapsed into a transportable collapsed position.

8. The display device of claim 7, further comprising at least one wheel and a handle.

9. The display device of claim 7, further comprising at locking mechanism disposed about the hinges and adapted to hold the device in the upright position.

10. A collapsible display system comprising:
a. a collapsible display unit, further comprising:
i. a plurality of links comprising first and second ends and disposed end-to-end in a generally stacked arrangement having a top and bottom;
ii. at least one video display; and
iii. a base unit; and
b. an operations interface;
wherein the hinges are disposed between the first and second ends of the links in the stacked arrangement and between the second end of the bottom link and the base unit; and
further wherein the operations interface is in operational communication with the at least one video display.

11. The display system of claim 10, further comprising a plurality of housings further comprising at least one display opening per housing disposed on the links.

12. The display system of claim 11, wherein two housings are disposed per link.

13. The display system of claim 11, wherein each link has a first and second side, and the housings are disposed on either side such that the display openings are oriented on opposite sides.

14. The display system of claim 11, further comprising an external communications unit in electronic communication with the operations interface.

15. The display system of claim 14, wherein the operations interface is disposed within the links to perform a support for the video display selected from the group consisting of: providing power, providing a communications signal, providing digital input, receiving digital output, and receiving audio output.

16. The display system of claim 11, further comprising at least one additional opening disposed within the system.

17. The display system of claim 16, wherein the additional opening is selected from the group consisting of power cord openings, speaker openings, wire openings, and button openings.

18. The display system of claim 10, wherein the system is configured to house at least one commercially-available video display.

19. The display system of claim 18, wherein the display system is configured to house at least one iPad.

20. The display system of claim 10, wherein the system further comprises at least one video monitor and at least one processing unit.
